(19) United States
(12) Patent Application Publication
(10) Pub. No.: US 2010/0246866 A1
(43) Pub. Date: Sep. 30, 2010

(54) Method and Apparatus for Implementing Hearing Aid with Array of Processors

(75) Inventors: Allan L. Swain, Whitmore, CA (US); Gibson D. Elliot, Oak Run, CA (US)

Correspondence Address: The TPL Group;C/O Alliacense Limited LLC, 20883 Stevens Creek Boulevard, Suite 100, Cupertino, CA, 95014, US

(73) Assignee: SWAT/ACR PORTFOLIO LLC, Cupertino, CA (US)

(21) Appl. No.: 12/483,998

(22) Filed: Jun. 12, 2009

Related U.S. Application Data
(63) Continuation-in-part of application No. 12/410,206, filed on Mar. 24, 2009, now abandoned.

(51) Int. Cl. H04R 25/00

(52) U.S. Cl. 381/315; 381/312; 381/321

(57) ABSTRACT

A method and apparatus for operation of a hearing aid 205 with signal processing functions performed with an array processor 220. In one embodiment, a reconfiguration module 250 allows reconfiguration of the processors 220 in the field. Another embodiment provides wireless communication by use of earpieces 105, 110 provided with antennas 235 in communication with a user module 260. The method includes steps of converting analog data into digital data 915 filtering out noise 920 and processing the digital data in parallel 925 compensating for the user's hearing deficiencies and convert the digital data back into analog. Another embodiment adds the additional step of reconfiguring the processor in the field 1145. Yet another embodiment adds wireless communication 1040-1065.

### CROSS-REFERENCE TO RELATED APPLICATIONS

This application is a continuation-in-part of co-pending U.S. patent application Ser. No. 12/410,206 entitled “Method and Apparatus for Implementing Hearing Aid with Array of Processors”, filed on Mar. 24, 2009, which is incorporated herein by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention pertains to hearing aids that are modular, scalable to the hearing deficiencies of the user. In particular, the invention pertains to methods and apparatus of implementing and controlling the different components of a hearing aid system, using an array of processors.

### BACKGROUND OF THE INVENTION

Electronic hearing aids typically include a microphone to receive sound and convert it to an electrical signal, a signal processor connected to the microphone that is operable to process the electrical signal and an earpiece or loudspeaker operable to convert the electrical signal to an acoustic signal produced at the ear of the user. The signal processor in such a hearing aid will carry out both amplification and filtering of the signal so as to amplify or attenuate the particular frequencies where the user suffers hearing loss. Such hearing aids can be mono, comprising a single earpiece, or stereo comprising a left and right earpiece for the user. Such devices are shown in U.S. application Ser. No. 10/475,568 by Zlatan Ribic filed Apr. 18, 2002 PCT/AT02/00114 and U.S. application Ser. No. 11/877,535 filed Oct. 23, 2007 also by Mr. Ribic.

Hearing aids come in different varieties, such as analog hearing aids and digital hearing aids. Analog hearing aids use transistors in a circuit to amplify and modify the incoming sound signal. Analog hearing aids are cheaper than digital hearing aids, but have limitations when used in noisy environments, as analog hearing aids amplify both sound signal (speech) and noise. Also, if the user needs any further adjustments with hearing, the user has to send the hearing aid back to the manufacturer to have the components changed.

Digital hearing aids provide improved processing power and programmability, allowing hearing aids to be customized to a specific hearing impairment and environment. Instead of a simple sound amplification, more complex processing strategies can be achieved to improve the sound quality presented to the impaired ear. However, to implement complex processing strategies, the hearing aid requires a very sophisticated digital signal processor (DSP). Owing to the computational burden of such processing, and the consequent requirements of complexity and speed, a main problem in using digital signal processing for hearing aids has been the size of the processor and the large amount of power used.

Hearing aid systems with remote control units allow configuring of hearing aid systems. Existing remote control units typically use cables to connect to the ear pieces. This wired approach is typically only used by medical professionals, such as audiologists, in a medical office environment. Wireless communication and specifically in the realm of radio frequency (RF) uses an antenna to receive a signal and a receiver for tuning the frequency to the desired signal frequency. At the other end is a simple transmitter to produce a signal at a certain frequency and an antenna for transmitting the signal. RF devices come in different varieties such as analog receivers and transmitters and digital receivers and transmitters. Analog receivers and transmitters are cheaper than digital receivers and transmitters, but have limitations such as changing components for changing the tunable frequencies.

Existing hearing aid systems thus far have properties which are predetermined after receiving power. Said properties are normally fixed by design and configured during manufacturing, for the purpose of targeting a specific marketing application, such as the hearing aid system described herein. Changing or expanding the properties of said systems to satisfy new application needs is limited to the static functions built in during manufacturing.

Thus, there exists a need for a digital hearing aid that can be programmed and customized to a specific hearing impairment and environment without posing limitations of significant power consumption, size requirements and speed requirements, plus utilizes a wireless remote control unit for convenient user programming in any environment.

### SUMMARY OF THE INVENTION

The proposed hearing aid system combines the advantages of digital signal processing and wireless digital receiving and transmission. It allows for much greater flexibility for the user in customizing the hearing aid to the environment and specific needs of the user based on their hearing loss. This is accomplished without imposing limitations of significant power consumption, size requirements and also speed requirements. It is also anticipated that this type of system would not be restricted to being used only by a medical professional. This system would be designed to allow the user to control the earpieces himself in any normal living environment. In addition, a wide variety of applications would be available to the user, over and above the typical hearing improvement functions.

Advances in semiconductor technology have enabled more and faster circuits that can operate with lower power consumption to be placed in a given die area, and advances in microprocessor architecture have provided single-die multiprocessor array, and stacked-die array, type computer systems in extremely compact form with capabilities for processing signals enormously faster and with very low operating power. One form of such a computer system is a single-die multiprocessor array, comprising a plurality of substantially similar, directly-connected computers (sometimes also referred to as “processors”, “cores” or “nodes”), each computer having processing capabilities and at least some dedicated memory, and adapted to operate asynchronously, both internally and for communicating with other computers of the array and with external devices. Moore, et al. (U.S. Pat. App. Pub. No. 2007/0250682A1) discloses such a computer system. Operating speed, power saving, and size improvements provided by such computer systems can be advantageous for signal processing application especially in digital hearing aids.

With an array of processors (also referred to as “cores”), some of the cores can be used to reconfigure a second set of cores, even while a third set of cores continue to run operations not related to the reconfiguration process. This process is known in the art as partial reconfiguration in the field, without doing any manufacturing. This ability greatly enhances the utility and lifetime of a product, such as, but not limited to, the hearing aid system described herein.

The hearing aid system described combines the advantages of digital signal processing and wireless digital receiving and transmission. This system allows for much greater flexibility for the user in customizing the hearing aid to the environment and specific needs of the user, based on their hearing loss without posing limitations of significant power consumption, size requirements and also speed requirements. This system is not restricted to being used only by a medical professional. The system allows the user to control the earpieces himself in any normal living environment. In addition, a wide variety of applications are available to the user, over and above the typical hearing improvement functions.

The proposed invention uses multiple processors or multiple computers for customizing a hearing aid to a user's hearing loss profile or to the hearing environment. A user interface device and hearing earpiece connect wirelessly, incorporating the digital receiver and transmitter onto an array of processors reducing power and improving the speed of the operations. A method for reconfiguring one set of an array of processors within a single system while the remaining array of processors in said system are simultaneously executing other operations.

### BRIEF DESCRIPTION OF THE FIGURES

FIG. 1 is a plan view of the physical components of an embodiment of the invention in a working environment;

FIG. 1a is a side elevation view of the physical components of the FIG. 1 embodiment;

FIG. 2 is a block diagram of an array earpiece and separate array user interface device;

FIG. 3 is a block diagram of the signal processing unit and reconfiguration module according to an embodiment of the invention;

FIG. 4 is a block diagram of the array earpiece antenna module according to an embodiment of the invention;

FIG. 5 is a block diagram of the array hearing aid according to an embodiment of the invention;

FIG. 6a is a block diagram of an array of processors in an embodiment of the invention;

FIG. 6b is a continuation of the block diagram of an array of processors in the FIG. 6a embodiment of the invention;

FIG. 6c is a continuation of the block diagram of an array of processors in the FIG. 6a embodiment of the invention;

FIG. 6d is a continuation of the block diagram of an array of processors in the FIG. 6a embodiment of the invention;

FIG. 6e is a continuation of the block diagram of an array of processors in the FIG. 6a embodiment of the invention;

FIG. 7a is a block diagram of an array of processors in an embodiment of the invention;

FIG. 7b is a continuation of the block diagram of an array of processors in the FIG. 7a embodiment of the invention;

FIG. 8 is a flow diagram of an embodiment of the method operation of the array hearing aid system;

FIG. 8a is a flow diagram of an embodiment of the method performing multiple frequency band processing;

FIG. 8b is a flow diagram of an embodiment of the method performing the spectral and temporal masking;

FIG. 9a is a flow diagram of an embodiment of the method performing the transmit of electromagnetic RF (wireless) energy;

FIG. 9b is a flow diagram of an embodiment of the method performing the receive of electromagnetic RF (wireless) energy;

FIG. 10a is a flow diagram of an embodiment of the method performing the reconfiguration module; and

FIG. 10b is a continuation of the FIG. 10a embodiment of the method.

### DETAILED DESCRIPTION OF THE INVENTION

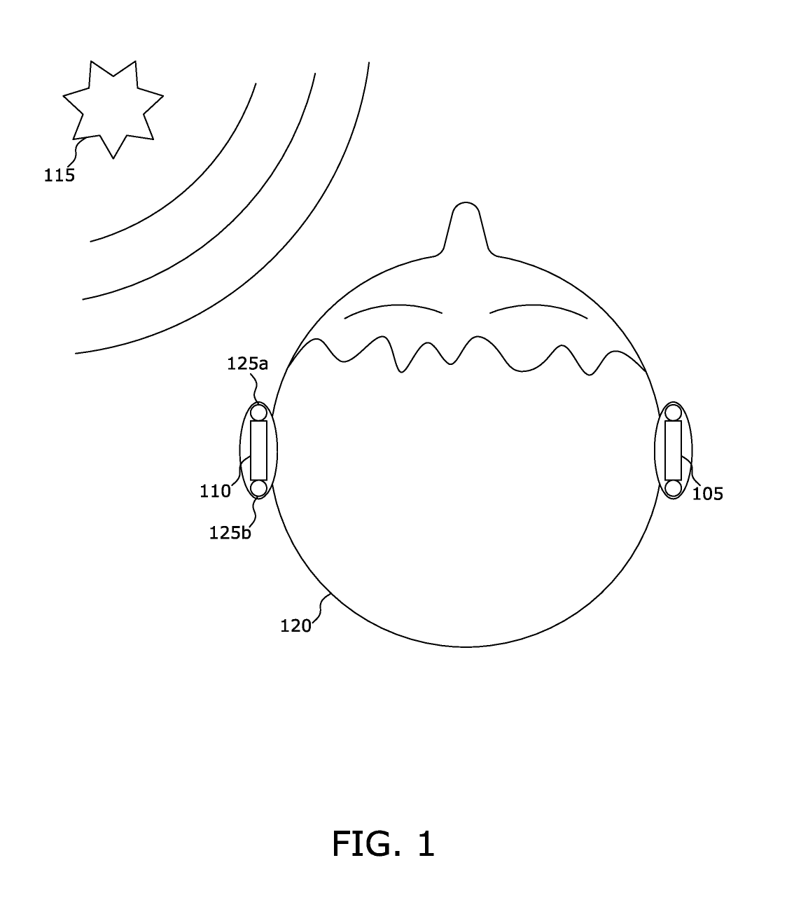

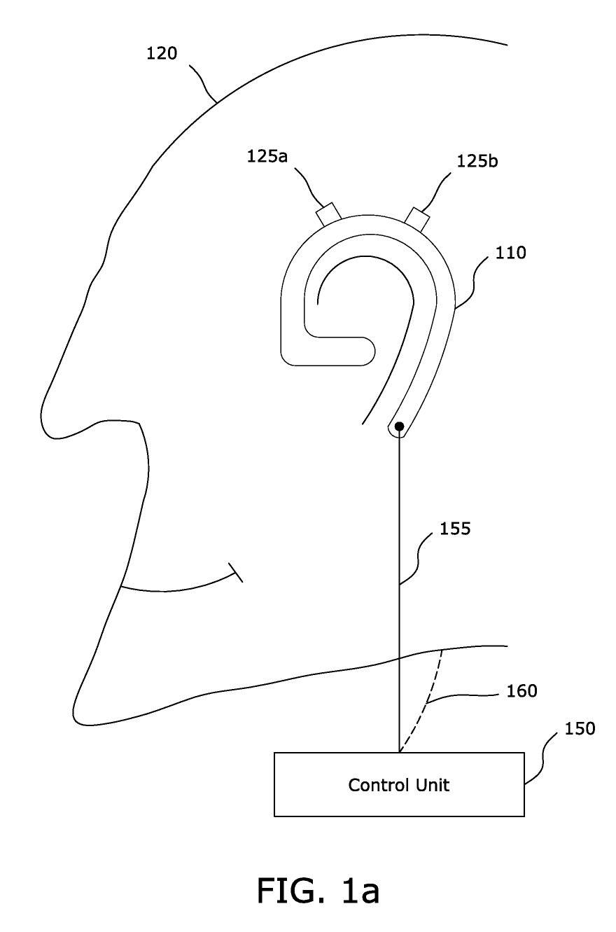

FIG. 1 is a plan view of the physical components of an embodiment of the invention in a working environment. The array hearing aid system includes a right earpiece 105, a left earpiece 110, and a user interface device 115. Each earpiece is substantially similar to the other and includes a front microphone 125a and a rear microphone 125b according to this embodiment. In alternate embodiments, a plurality of microphones greater than two may be included in the earpiece. The system reproduces processed sound to the cochlea of the inner ear which amplifies and attenuates the particular frequencies where a user 120 suffers hearing loss. An interface device 115 permits the user 120 to customize the hearing aid system to fit the particular needs of the individual user's 120 hearing loss profile or the user's 120 listening environment.

FIG. 1a is a side elevation view of the physical components of an alternate to the FIG. 1 embodiment. An over the ear, earpiece 110 is shown connected to a control unit 150 via a wire 155. Also shown is a separate wire 160 connecting the right earpiece 105 (not shown) to control unit 150. In an alternate embodiment, the earpiece 110 is seated within the ear while still connected via wire 155 to the control unit 150. The control unit 150 functions as a continuous power supply to the right earpiece 105 (not shown) and left earpiece 110. According to one embodiment, the left earpiece 110 does not contain a power storing mechanism, hence the need for the left earpiece 110 to be constantly connected with the control unit 150 via wire 155. The power supplied by the control unit 150 is produced accordingly by battery, solar, or other suitable power generation sources. The power supplied to the left earpiece 110 is required to be greater than the minimum power supply needed for the signal processing of attenuating or amplifying particular frequencies where the user 120 suffers hearing loss. The control unit 150 is meant to be worn on the user 120 and therefore small enough to fit in a front shirt pocket, front pants pocket, rear pants pocket, or other suitable place within a reasonable distance of the user.

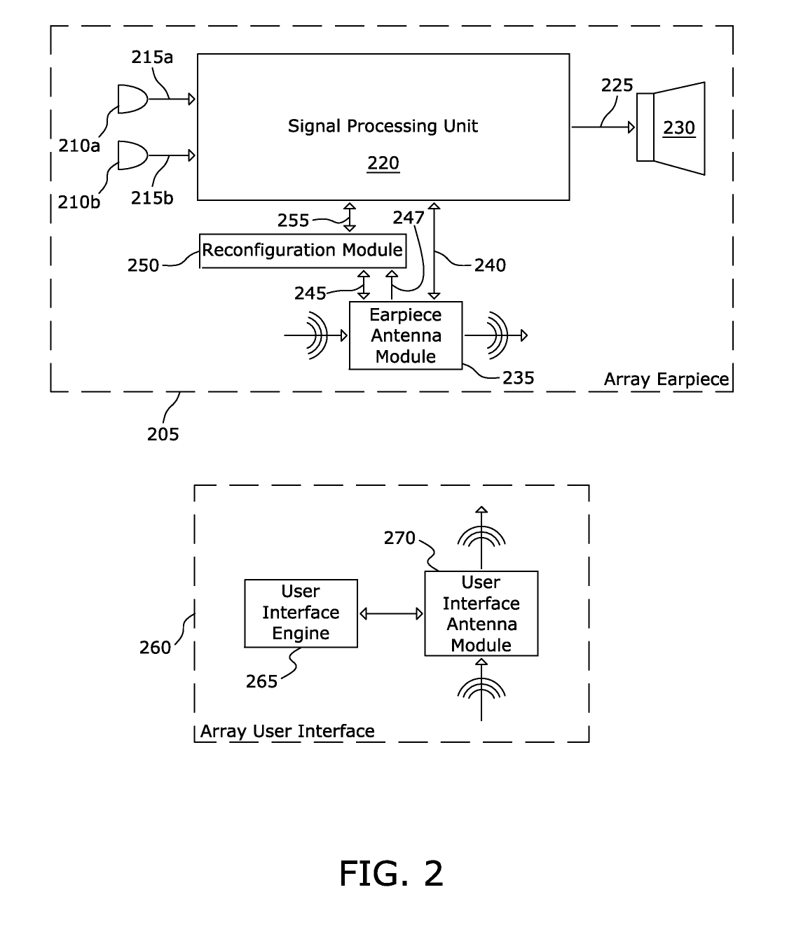

FIG. 2 is a block diagram of the hearing aid system in the FIG. 1 embodiment. The blocks described hereinbelow should be understood to represent signal processing functions performed by the array hearing aid in general, and not its actual circuit layout and arrangement. An array earpiece 205, including a front microphone 210a, is connected by data and control paths (herein referred to in short as “path”) 215a to a signal processing unit 220. A rear microphone 210b is further connected by path 215b to signal processing unit 220. Microphones 210a and 210b are transducers which produce an electrical signal proportional to the received acoustic signal. Signal processing unit 220 is responsible for amplifying or attenuating the particular frequencies where user 120 of FIG. 1 suffers hearing loss. Returning to FIG. 2, a path 225 connects the output of signal processing unit 220 to an earphone 230 operable to reproduce sound for user 120 (not shown). The array earpiece further includes an earpiece antenna module 235 operable to transmit and receive electromagnetic RF (wireless) energy and is connected by means of a path 240 to signal processing unit 220 and connected by means of a path 245 and a path 247 to a reconfiguration module 250 for modifying operation of signal processing unit 220. Connecting reconfiguration module 250 and signal processing unit 220 is a path 255.

An array user interface 260, including a user interface engine 265, is operable by user 120 of FIG. 1 (not shown), the interface allows the selection of inputs which in turn modify signal processing unit 220. User interface engine 265 is connected to a user interface antenna module 270 operable to transmit and receive electromagnetic RF (wireless) energy.

In the FIG. 1a embodiment, array the user interface is in control unit 150 connected by means of a wire 155 to array earpiece 110. As a consequence, the user interface antenna module 270 and earpiece antenna module 235 of FIG. 2 are replaced with a wire connection.

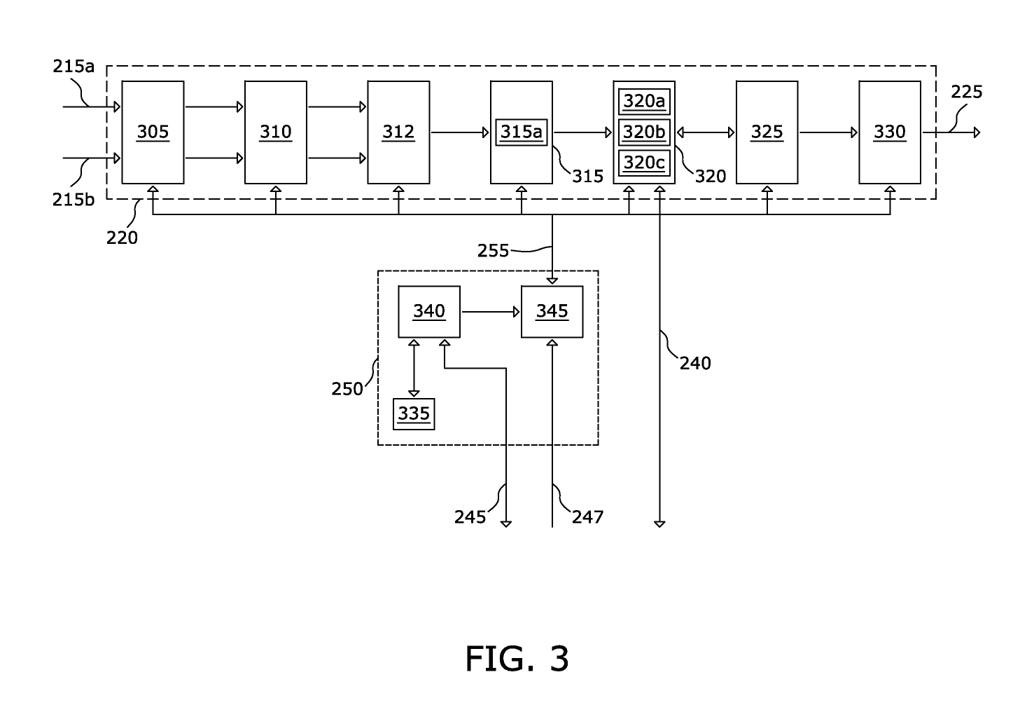

FIG. 3 is a block diagram that details signal processing unit 220 and reconfiguration module 250 of FIG. 2. Signal processing unit 220 includes a pre-amplifier 305 that amplifies the signal provided by the paths 215a and 215b to a level where it can be converted to a digital signal by an analog to digital (A to D) converter 310 and subsequently be processed by the multi-band processing unit 315 and compensation unit, herein also referred to as a compensation unit 320.

A to D converter 310 converts the analog electrical signal received from pre-amplifier 305 into a discrete digital signal that can subsequently be processed by digital signal processing means. The output of A to D converter 310 is connected to the input of a directional microphone 312. The output of directional microphone 312 is connected to the input of the multi-band processing unit 315 which is, in turn, connected to the instant amplitude control unit (IACU) 320. Multi-band processing unit 315 includes a filter bank 315a, which includes a bank of band pass filters operable to separate the input signal into a plurality of frequency bands. The output of IACU 320 is connected to the input of the post processing amplifier 325. Post processing amplifier 325 amplifies the signal received from compensation unit 320 to a level where it can be reproduced as sound at earphones 105 or 110 of FIG. 1 after subsequent conversion to an analog signal by the digital to analog converter 330.

IACU 320 processes the signal received from multi-band processing unit 315 to compensate for the hearing defects present in a person suffering from hearing loss, including cochlear hearing loss. IACU 320 is operable to receive corresponding frequency band signals from multi-band processing unit 315 and process each frequency band signal separately. Processing the frequency bands is accomplished by means of a distinct analytic magnitude divider (AMD) 320a, each operable to provide dynamic compression, attenuating signals of amplitude greater than a threshold value and amplifying signals below said threshold. The threshold value and compression ratio of each AMD 320a is predetermined to the hearing loss profile of a particular user 120 of FIG. 1 using the array hearing aid system. Dynamic compression acts to reduce the dynamic range of signals received at the ear and accordingly reduces the masking effect of loud sounds. In addition, as will be described below, the compression algorithm of each AMD 320a provides spectral contrast enhancement to compensate for simultaneous masking at nearby frequencies in the frequency domain and introduces inter-modulation distortion that mimics the distortion produced naturally by a healthy cochlea. Thus, the AMD 320a is operable to at least partially compensate for all of the three above-mentioned effects associated with cochlear hearing loss. An equalizer bank 320b applies a predetermined amount of gain to the output of each AMD 320a. The amount of gain is predetermined to the hearing loss profile of each particular user 120 of FIG. 1 using the array hearing aid system by means of an audiometric procedure. A signal adder 320c adds the output signals of equalizer bank 320b to reconstruct the signal so that it can be output as sound by earphones 105 or 110 of FIG. 1.

Reconfiguration module 250 includes a non-volatile memory (“NVM”) 335 connected to a code processor unit 340, whose output is connected to reconfiguration unit 345. The path 245 connects a reconfiguration unit 345 and code processor unit 340 with earpiece antenna module 235 of FIG. 2.

The code processor unit 340 is operable to download a set of commands which subsequently execute instructions that configure the reconfiguration unit 345. Optionally, some or all of the commands used to configure reconfiguration unit 345 may come from NVM 335. In the latter case, a reconfigure initiate command received from earpiece antenna module 235 of FIG. 2 by means of path 247 begins the reconfiguration of the functional blocks as part of the signal processing unit 220 of FIG. 2.

In one embodiment pre-amplifier 305, analog to digital converter 310, directional microphone 312, multi-band processing unit 315, compensation unit 320, post processing amplifier 325, and digital to analog converter 330 are all functionally reconfigured. In an alternate embodiment, not all of the functional blocks as part of the signal processing unit 220 are reconfigured. Device partial reconfiguration will proceed without interrupting other functional components of the array hearing aid system.

In an alternative embodiment, reconfiguration module 250 is operable to functionally manipulate data used in signal processing unit 220. For example, compensation unit 320 uses a compression ratio parameter, gain for each frequency, and a master gain parameter which are used in the reformulation of the audio signal from the eight frequency bands. It is possible to update any of the three parameters in compensation unit 320 for each clock sample. Path 245 from earpiece antenna module 235 (FIG. 2 not shown) connected to code processor unit 345 receives an adjustment indicator from array user interface 260 (FIG. 2 not shown). Code processor unit 340 will use the adjustment indicator to interact with NVM 335 and pass new parameters to compensation unit 320 by means of configuration unit 345 and path 255. Path 247 from earpiece antenna module 235 (FIG. 2 not shown) connected to configuration unit 345, receives the new parameters and configures them for use in compensation unit 320 directly. Hence, the new parameters are stored in array user interface 260 (FIG. 2 not shown) and transmitted via user interface antenna module 270 (FIG. 2 not shown) to earpiece antenna module 235 (FIG. 2 not shown).

Returning to FIG. 2, in another alternate embodiment, the new parameters are stored in user interface 260 and transmitted via user interface antenna module 270 to earpiece antenna module 235 and passed to compensation unit 320 (FIG. 3 not shown) by means of path 240. In this embodiment, the reconfiguration module is not needed for the change of the parameters in compensation unit 320 (FIG. 3 not shown).

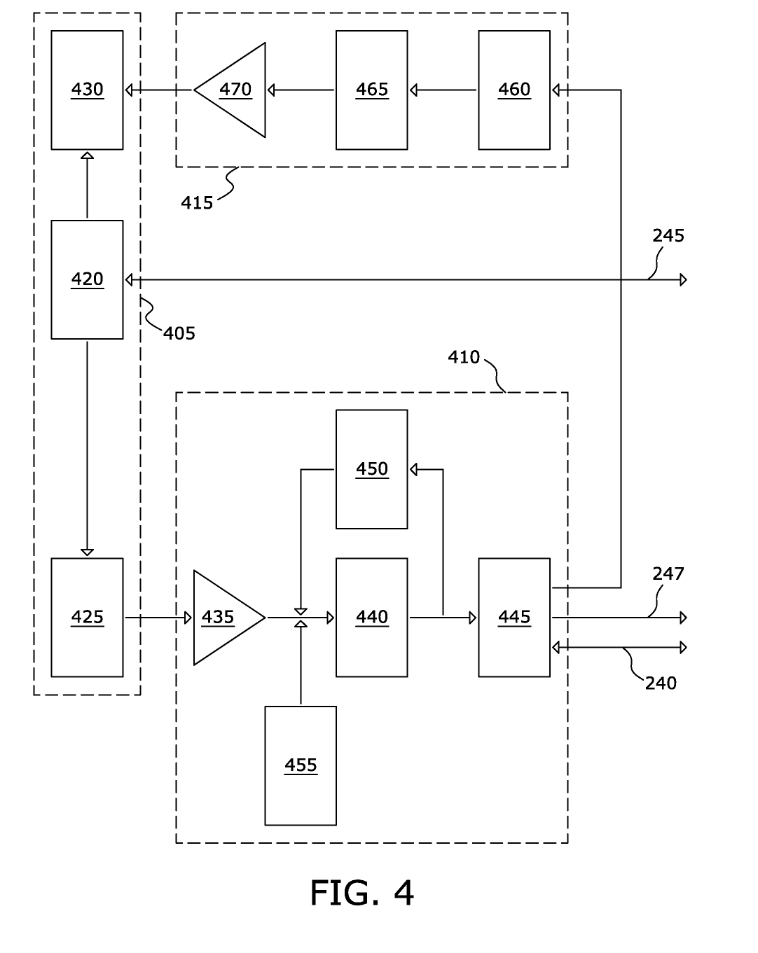

FIG. 4 is a block diagram that details earpiece antenna module 235 of FIG. 2, according to an embodiment of the invention. Earpiece antenna module 235 includes a dual purpose receive and transmit antenna 405, a simple receiver 410, and a simple transmitter 415. Dual purpose receive and transmit antenna 405 includes a switching logic 420, an earpiece receiver antenna 425, and an earpiece transmit antenna 430. In an alternate embodiment, the dual purpose receive and transmit antenna 405 is one physical antenna structure. Switching logic 420 defines dual purpose receive and transmit antenna 405 for the transmit or receive function of the physical antenna structure.

The output from dual purpose receive and transmit antenna 405 is connected to simple receiver 410 when earpiece antenna module 235 is receiving a signal from array user interface 260 of FIG. 2. In an embodiment, simple receiver 410 is a super regenerative receiver that includes a low noise amplifier (“LNA”) 435 whose output is connected to an RF detector 440. The output from RF detector 440 is connected to a baseband amplification and low pass filter 445 and a frequency selection and feedback 450. The output of the latter is connected back to RF detector 440. Finally, a quench ramp generator 455 output is also connected to RF detector 440.

The input to the dual purpose receive and transmit antenna 405 is connected from simple transmitter 415 when earpiece antenna module 235 is transmitting a signal to array user interface 260 of FIG. 2. Simple transmitter 415 includes a puck oscillator 460, whose output is connected to an OOK gate 465, whose output is connected to a power amplifier (PA) 470.

User interface antenna module 270 is functionally equivalent to the earpiece antenna module 235. However, dual purpose receive and transmit antenna 405, as part of the user interface antenna module 270, is operable to transmit to array earpiece 205 and receive from array earpiece 205.

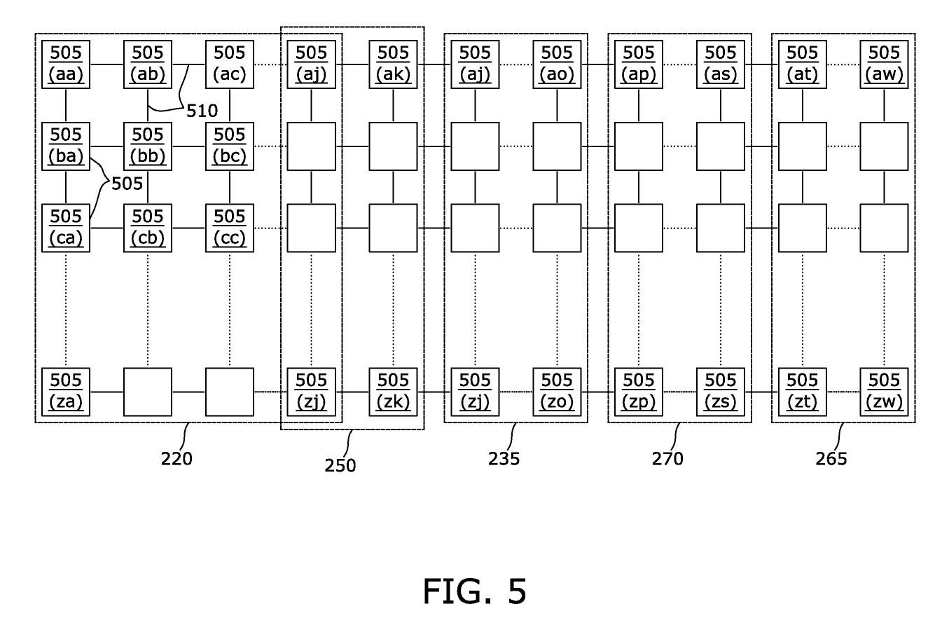

FIG. 5 illustrates a system level implementation of the array hearing aid system by using an array of processing devices 505(aa) to 505(zw), according to an embodiment of the invention. In this embodiment, as shown in FIG. 2, each processing device 505(aa) to 505(zw) is connected to a plurality of neighboring processing devices orthogonally. Each processing device communicates with neighboring processing devices over a single drop bus 510 that includes data lines, read control lines, and write control lines. There is no common bus. For example, processing device 505(bb) communicates with four neighboring processors 505(ba), 505(ab), 505(bc), and 505(cb), using buses 510. In an alternate embodiment, a diagonal intercommunication bus (not shown) could be used to communicate between diagonally neighboring processors instead of or in addition to the present orthogonal buses 510. For example, processing device 505(bb) would communicate with neighboring processors 505(aa), 505(ac), 505(ca), and 505(cc). According to the invention, the functional tasks performed by the array hearing aid system such as signal processing unit 220, reconfiguration module 250, earpiece antenna module 235, user interface antenna module 270, and user interface engine 265 are distributed on the array of processing devices 505(aa) to 505(zw).

In one embodiment, the task of each unit of the hearing aid system is further divided into a plurality of smaller tasks, such that the smaller tasks can be executed by one or more of the processing devices 505(aa) to 505(zw). Dividing the tasks into smaller tasks and distributing the tasks to the plurality of the processing devices allows the system to execute the multiple tasks simultaneously in parallel. Furthermore, once the individual processing unit completes the tasks assigned to it, the processing device can enter into a power saving mode. For example, the processors 505(aa) to 505(zj) are assigned to perform the tasks of the signal processing unit 220, processors 505(aj) to 505(zk) are assigned to perform the tasks of the reconfiguration module 250, processors 505(al) to 505(zo) are assigned to perform the tasks of the earpiece antenna module 235, processors 505(ap) to 505(zs) are assigned to perform the tasks of the array user interface 260, and processors 505(at) to 505(zw) are assigned to perform the tasks of the user interface engine 265.

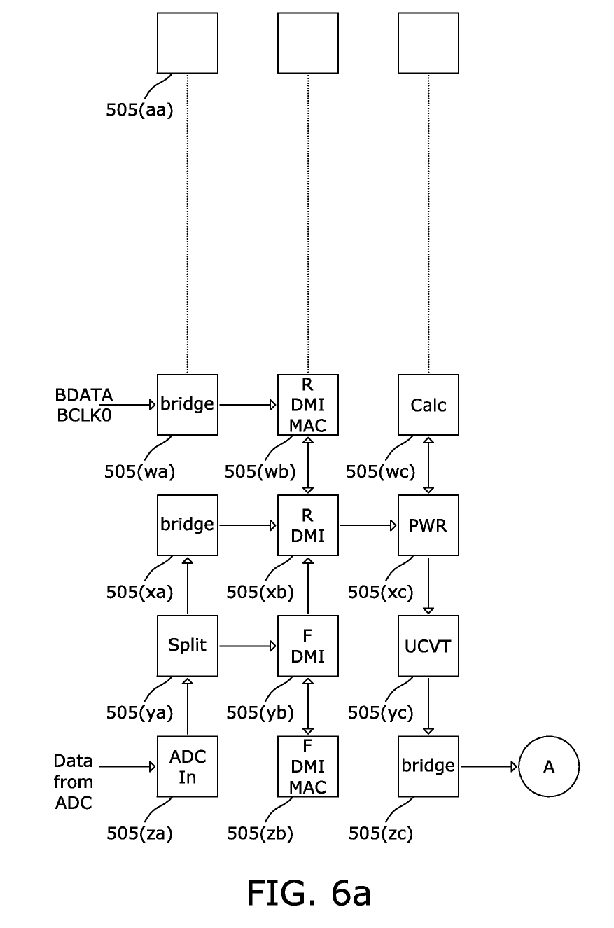

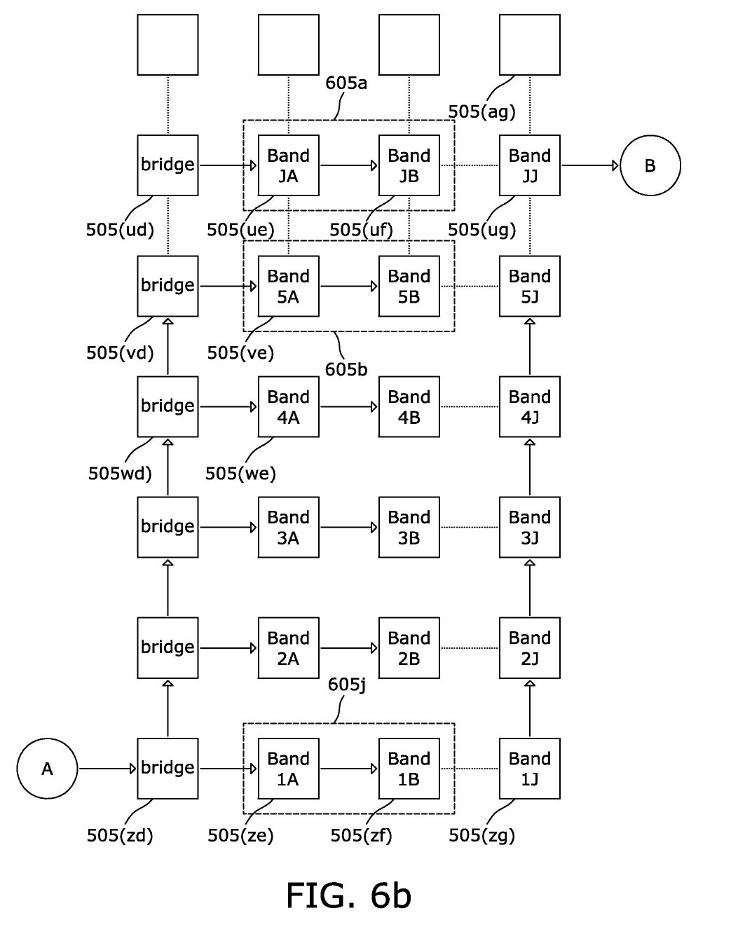

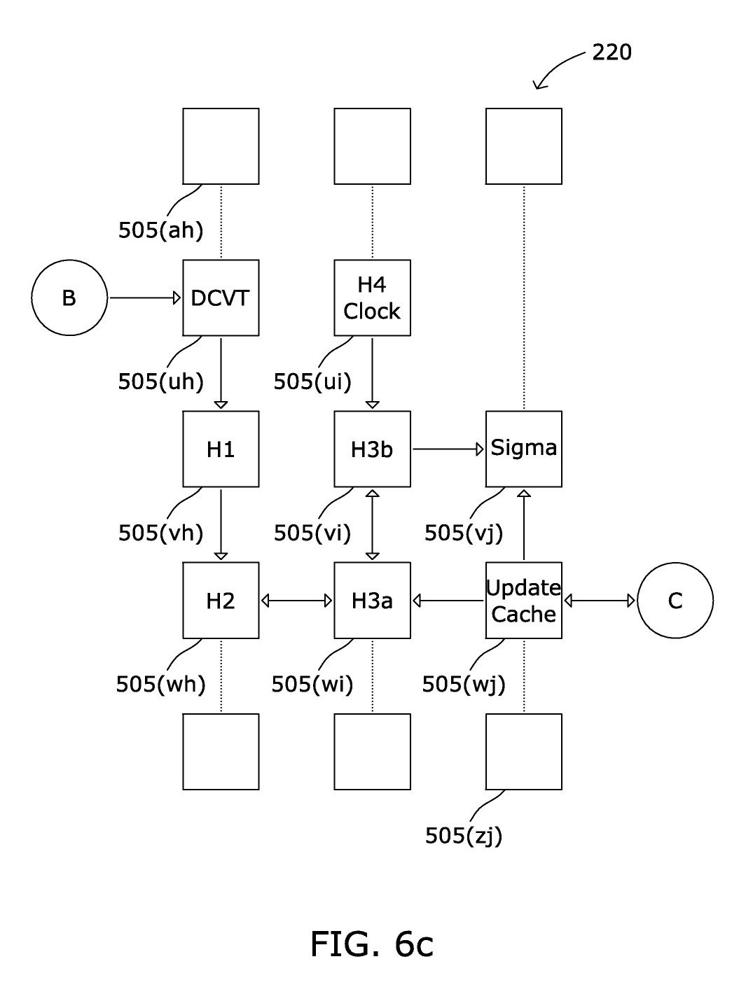

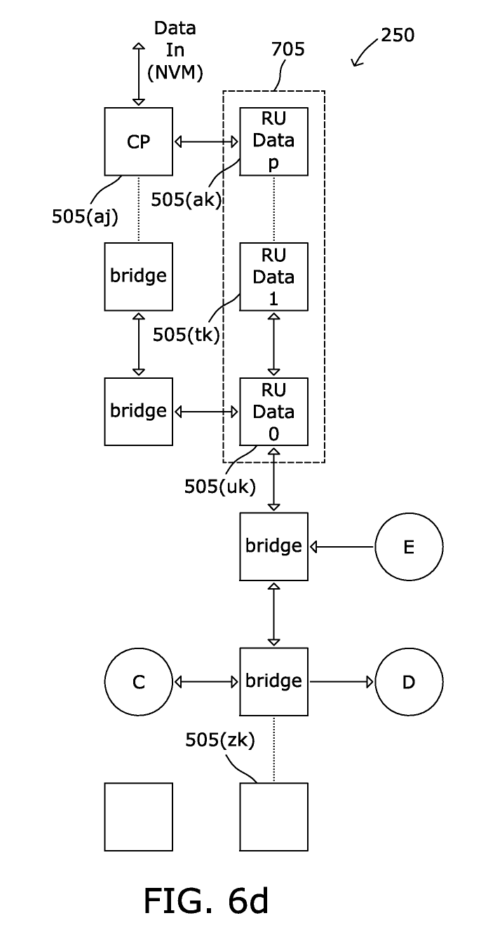

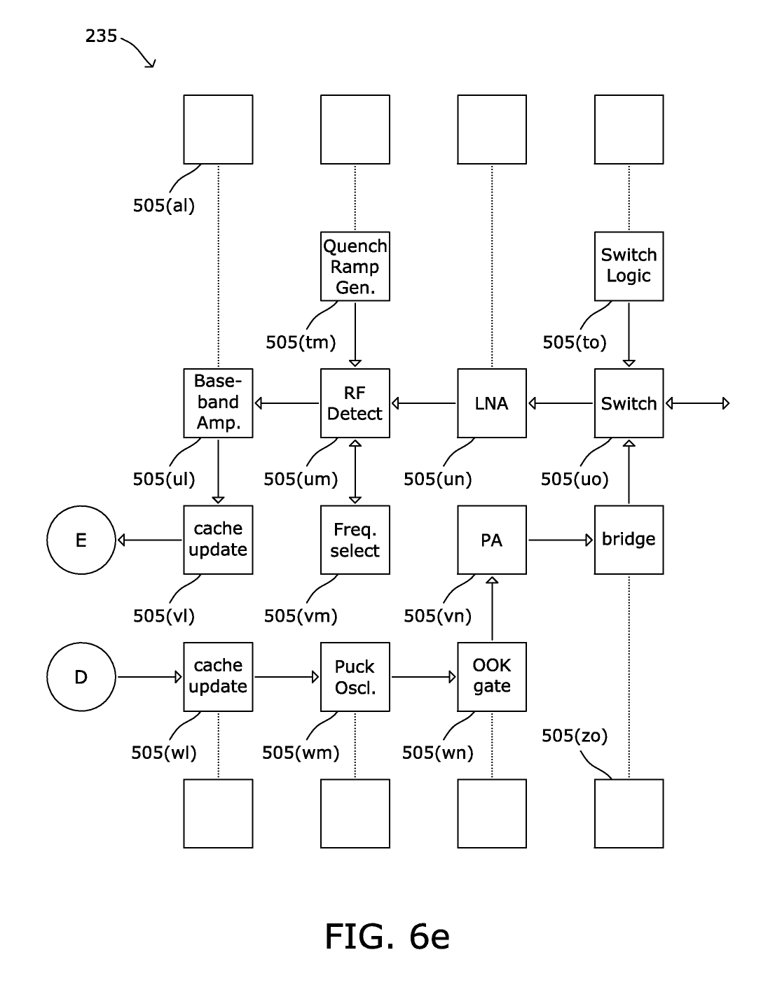

FIG. 6, divided into sections 6a, 6b, 6c, 6d and 6e (connected by A, B, C, D, and E) all connected serially illustrate the array of processors used to perform noise filtering, multiple frequency band processing as an embodiment of the signal processing unit 220 (FIG. 5).

In FIG. 6a the data received from the analog to digital converter is received by processing device 505(za) and then provided to processing device 505(ya), which acts as a splitter that separates the data channels from the front and rear microphones 210a and 210b, FIG. 2, to perform the noise filtering, the hearing device employs an average power calculator, an integrator steered by the power difference, and blocks to combine the intermediate terms.

Returning to the FIG. 6a embodiment, the array hearing aid device performs the noise filtering by providing data channel from rear microphone 210b of FIG. 2 to processing devices 505(xb) and 505(wb), acting as the directional microphone (R-DMI and RDMI-MAC), and the data channel from front microphone 210a of FIG. 2 is provided to processing devices 505(yb) and 505(zb) as the directional microphone interface (F-DMI and FDMI-MAC). Each processing device 505(xb), 505(wb), 505(yb), and 505(zb), acting as the directional microphone interface produces a signal by combining the data channels with a differential phase shift between them. The data from the directional microphone interface is provided to processing devices 505(wc) and 505(xc) to calculate the average power. Processing devices 505(wc) and 505(xc), acting as the average power calculator blocks, create a weighted portion of the absolute values of the output front channel and the shifted channel. The two outputs are then subtracted and the sign bit is passed to the phase tracking blocks. The average power difference between the two DMI channels is scaled by the constant and drives a second integrator with an internal delay.

Moving on to FIG. 6b through connection A to bridge 505(zd) and divided into bands by bridges including 505(wd), 505(vd) and 505(ud) the number of bridges and bands is determined by how much processing is needed for the particular application. The noise filtered data is next processed by a plurality of processing devices to improve the hearing ability of the user. A multi-band processing unit is implemented by using a series of processing devices 505(ud) through 505(zg). The noise filtered data is provided to plurality of processing devices 505(ud) through 505(zg), and the data is provided to processing devices 505(ue) through 505(ze), acting as digital filters. In one embodiment, processing devices 505(ue) through 505(uf) each act as a first order filter from a nth order filter 605j to provide data operating in a frequency band (Band-1). The nth order filters 605a through 605j can operate simultaneously as soon as the data is available to the filters, thus performing signal processing at a much faster pace.

In one embodiment, the processing devices of FIG. 6a and FIG. 6b, 505(aa) through 505(zg), can be programmed to return to their designated tasks and return to a power-saving mode, thus saving the amount of power consumed performing the filtering operation.

In another embodiment, processing devices 505(xa), 505(wa) and 505(zc) in FIG. 6a and processing devices 505(ud) through 505(zd) in FIG. 6b referred to as bridges, receive data from a neighboring processing device and then pass the data to another processing device connected to it. The bridge processing devices return to a power saving mode, thus saving the power consumed when not performing the passing of data from/to neighboring processing devices.

In another embodiment as illustrated in FIG. 6b, the data is routed to the processing devices such that the tasks of the hearing aid system can be performed in the time and power efficient manner. For example, the data, after being filtered for noise, is provided to processing devices 505(ud) through 505(zd) beginning at processing device 505(zd) through 505(ud). The nth order filters 605j through 605a begin filtering the data as soon as the data is provided by processing devices 505(zd) through 505(ud). Nth order filter 605j begins with the signal processing followed by nth order filters 605i through 605a. The data provided by nth order filters 605j through 605a are added by signal adder 320b of FIG. 3 as the data becomes available to construct a complete signal. The completed signal is provided to compensation unit 320 for further processing.

In yet another embodiment, the array of processors may be asynchronous in the communication between the processors, with asynchronous instruction execution by the individual processors. The synchronicity necessary for signal processing functionality is accomplished by synchronizing software running on each processor in the asynchronous array of processors.

FIG. 6c illustrates the array of processors 505(ah) through 505(zj) used to perform data compensation as part of signal processing unit 220. Processing device 505(uh) down converts (“DCVT”) the processed band samples and passes them to the six processing devices 505(vh), 505(vh), 505(vi), 505(ui), 505(vi), and 505(vj) that perform the function of the analytic magnitude divider (“AMD”). A distinct AMD associated with each band provides dynamic compression, attenuating signals of amplitude greater than a threshold value and amplifying signals below said threshold. The threshold and compression ratio of each AMD is predetermined to the hearing loss profile of a particular user. Dynamic compression acts to reduce the dynamic range of signals received at the ear accordingly reduces the masking effect of loud sounds. The compression algorithm of each AMD provides spectral contrast enhancements to compensate for simultaneous masking at nearby frequencies in the frequency domain and introduces inter-modulation distortion that mimics the distortion produced naturally by a healthy cochlea. An equalizer bank within the signal reconstruction unit applies a predetermined amount of gain to the output of each AMD when reformulating the signal to produce sound at the ear of the user. Cache update 505(tj) transmits information to configure 505(ti) as well as update information to FIG. 6d via C.

The outputs from the multi-band audio processor are compressed to provide spectral and temporal unmasking. The real and real/imaginary & magnitude/phase components of the signals in the band are first generated using a simple Hilbert transform. The Hilbert transform is performed by four processing devices, 505(vh), 505(uh), 505(vi), and 505(ui). The absolute value of the magnitude component is then offset by a minimal threshold and compressed using a pre-calculated compression ration term as an exponent. The compression ratio for all bands is adjustable by a compression ratio parameter, which is determined by the hearing loss profile of user 120. At higher compression ratio states, the amount of IM distortion is enhanced in the output signal as well. The slope of the compression ratio parameters over the filter spectrum is adjustable over a range of zero to one.

FIG. 6d illustrates the array of processors 505(aj) through 505(zk) used to perform the function of the reconfiguration module 250, FIG. 2. For purposes of illustration, an example of target cores could be array devices 505(sk), 505(rk) and 505(ak) on FIG. 6d, herein referenced as RU 705. However, the number of target array devices is only dependent on the complexity of the functions being performed by each target core. Prior to receiving the initiate reconfiguration command, RU 705 receives reconfiguration data and instructions from a code processor herein referenced as CP 505(aj). Reconfiguration instructions and data are loaded directly from the cache update 505(tj) FIG. 6c and/or NVM 335 of FIG. 3 into the CP 505(aj). The CP configures RU 705 in preparation for reconfiguration of signal processing unit 220. The initiate reconfiguration command is sent from user interface device 115 of FIG. 1.

FIG. 6e array of processors 505(al) through 505(zo) illustrates the array of processors used to operate as earpiece antenna module 235. The input from the physical antenna (not shown) is connected to a switch 505(so). A switching logic 505(ro) controls the switch and determines if the switch 505(so) will send or receive a wireless RF signal. In one embodiment, the earpiece antenna module 235 (FIG. 2) is receiving a signal. Switch 505(so) connected to a digital low noise amplifier (“LNA”) 505(sn), whose output is connected to a digital RF detector 505(sm). The RF detector 505(sm) has inputs from the digital quench ramp generator 505(rm) and a digital frequency select & feedback 505(tm). Output from the RF detector 505(sm) is back to the frequency select & feedback 505(tm), as well as to a digital baseband amplifier 505(sl).

In an alternate model, earpiece antenna module 235 (FIG. 2) is sending a signal. A digital puck oscillator 505(um) is connected to a digital on/off keying (“OOK”) gate 505(un) which is connected to a digital power amplifier (“PA”) 505(tn).

Signals are received at the antenna and are initially amplified (using an LNA) and filtered to produce a strong enough signal to allow reliable sampling. The sampling here is done with a super regenerative receiver (“SRR”) technique.

The oscillator 505(um) for the SRR is intentionally designed with positive feedback, and a very narrow Q. Also, it is designed to have a ramp up delay time which is a known value when the received signal does not contain the desired frequency. The ramp delay time rapidly decreases when the desired frequency is present at the LNA. The SEAforth® code is very well suited to measuring signal delay times. So the code can quickly determine if the desired signal frequency is present, by tracking the oscillator ramp up time. When that happens, the code can essentially disable the oscillator briefly with a digital bit line (known as Q-quenching), then release the line, allowing the oscillator to ramp up again. Also, when the “quick” ramp up occurs, the oscillator current (Iosc) increases proportionally to the ramp up time. When Iosc crosses a pre-determined threshold (Ithresh), the SEAforth® code records that as a valid sample of the desired frequency. This entire sampling process then repeats for each sample. At this point, the sampling process follows techniques well known in the art such as the Nyquist requirement that you must sample at least 2× faster than the detected frequency. One method for detecting Iosc is to convert it to a voltage with a resistance, then use the SEAforth® on-chip ADC to measure the voltage. Currently, some other analog functions may have to be done externally, such as signal pre-conditioning. But eventually those small circuits could be included on the SEAforth® chip.

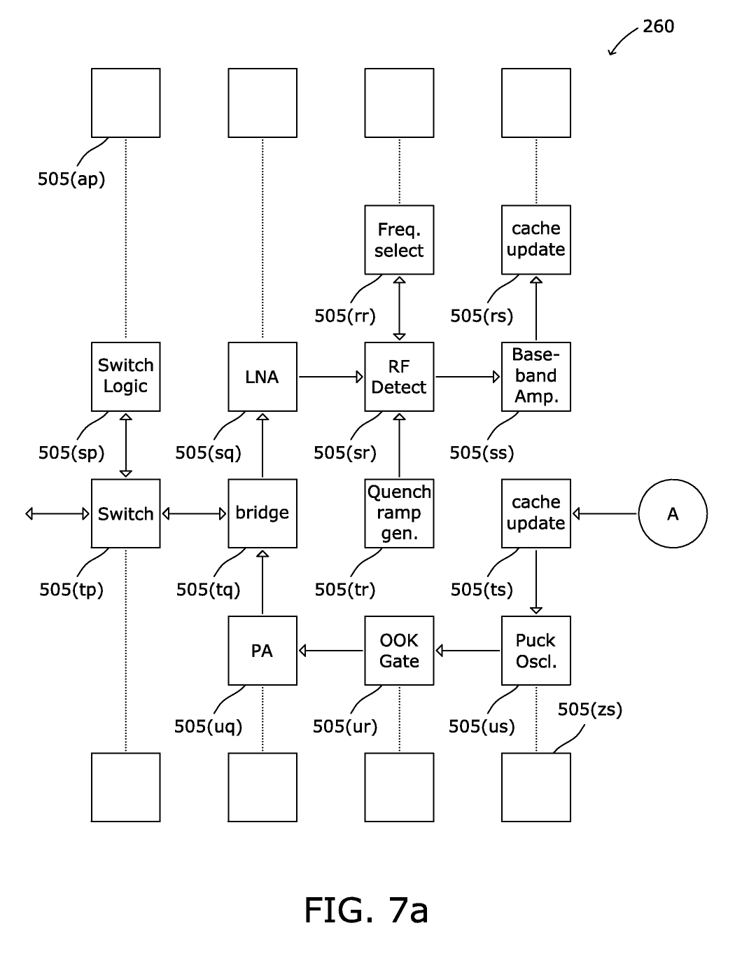

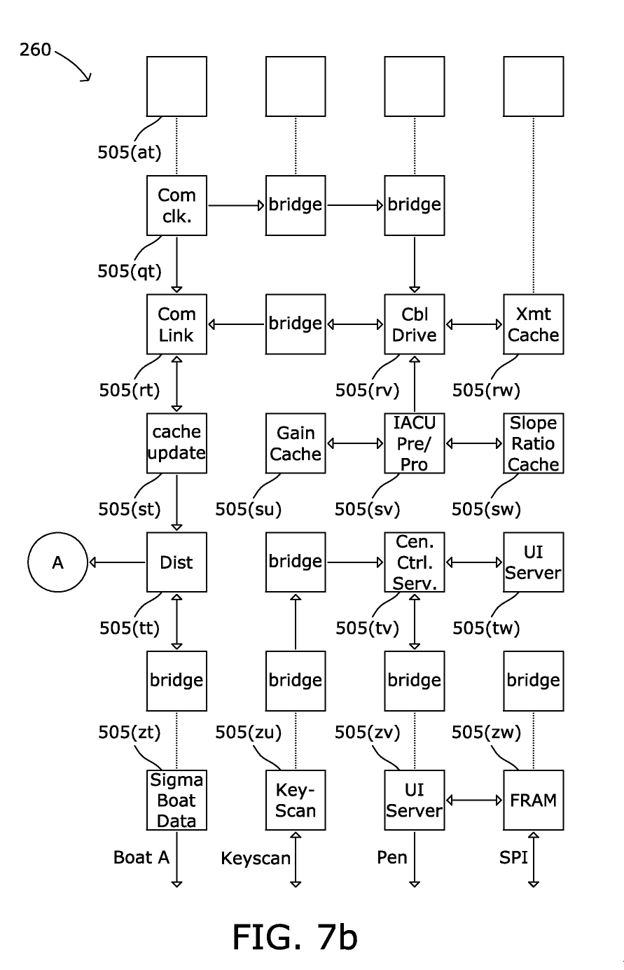

FIGS. 7a and 7b illustrate an embodiment of the array of processors used to operate as user interface antenna module 260 and user interface engine 265 shown in FIG. 3. User interface antenna module 260 of FIG. 3 is implemented by using array of processors 505(ap) through 505(zs) of FIG. 7a. User interface engine 265 of FIG. 3 is implemented by using array of processors 505(at) through 505(zw) shown in FIG. 7b. User interface engine 265 manages user interface device 115 and modifies data according to a state machine of the controller. User interface device 115 transitions from one state of a user interface state model to the next on receiving data from user 120, by entering the keys on the processing device.

Returning to FIG. 7b, the keys inputted by the user are processed by performing a keyscan operation at processor 505(zu). Based on the keys entered by user 120 (not shown) and received by the processing device performing keyscan operation 505(zu), the processing device, acting as the central controller 505(tv) commands and fetches the updated slope ratios from the processing device acting as the slope ratio cache 505(sw) and the updated gains from processing device acting as the gain cache 505(su). The updated values are provided, again, to compensation unit 320 for further adjustments of the data based on the new inputs from user 120.

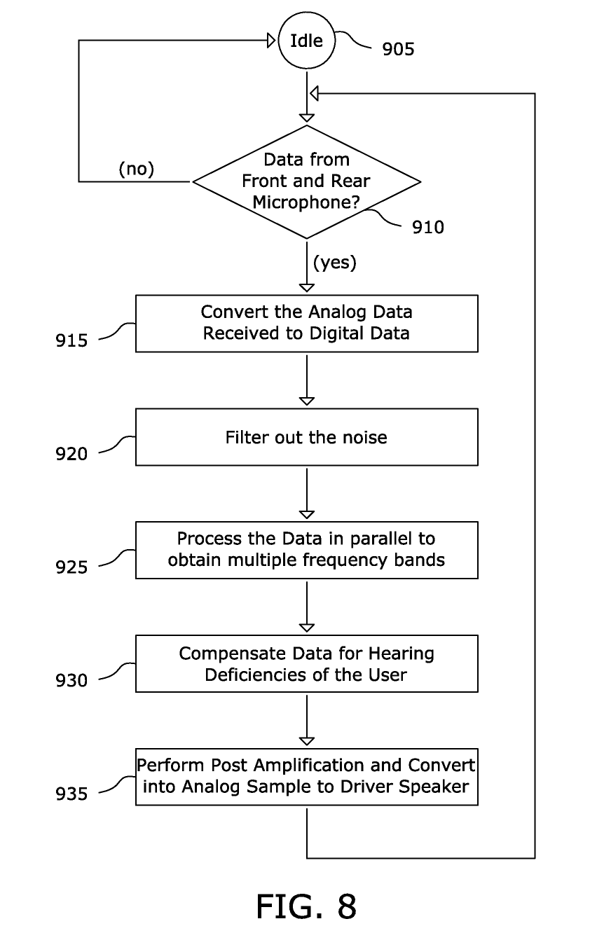

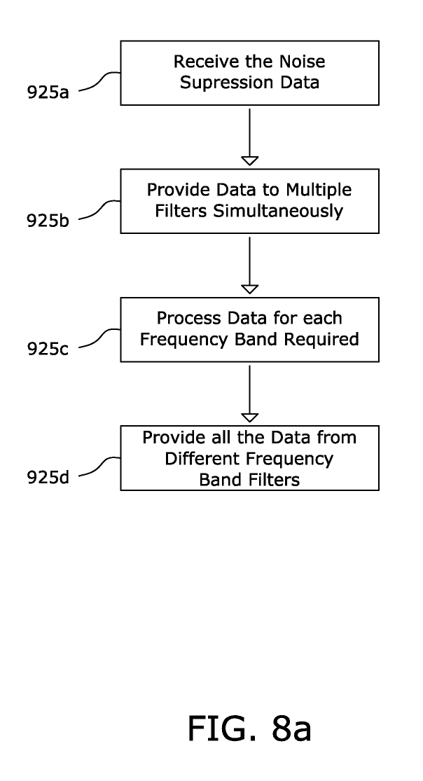

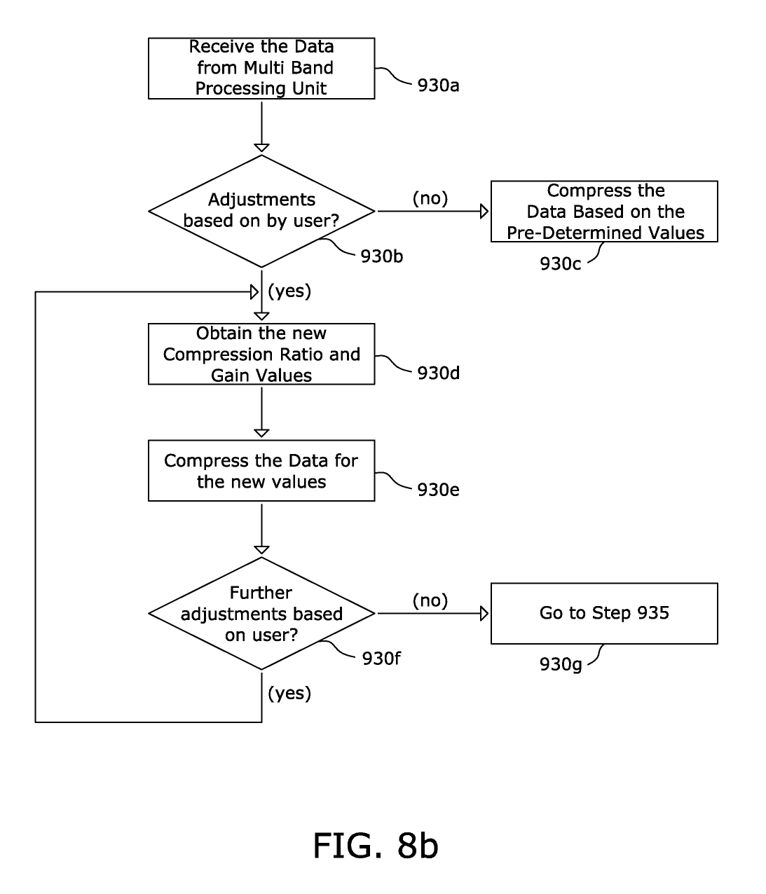

FIG. 8 is a flow chart depicting an embodiment of the method of the operation of the array hearing aid system. Hearing aid device is programmed to operate in the idle state on receiving power (step 905). Front and rear microphones (210a and 210b), on receiving the acoustic signals, convert them into an electrical signal (step 910). A to D converter 310 converts the analog data from step 910 into a discrete digital signal (step 915). The digital signal received from A to D converter 310 is filtered for noise by using an array of processors as shown in FIG. 8 (step 920). The data, after being filtered for noise, is processed by plurality of filters to obtain plurality of frequency bands data (step 925) which is explained in FIG. 8 (step 925). The different data bands are compensated for the compression ratios and gains based on the hearing deficiencies of user 120 (step 930). After making adjustments for the hearing deficiencies, the data is amplified further and provided to D to A converter 330 to be converted back to an analog signal. The signal is provided at earphones 105, 110 of the user and returns back to the idle state (step 935). In one embodiment, the steps (910 through 935) can be divided into multiple steps and performed by plurality of processing devices 505(aa) through 505(zw).

FIG. 8a is a flow chart depicting how step 925 of flowchart in FIG. 8 can be divided into multiple steps (925a through 925d) wherein array hearing aid device receives the data filtered for noise in step 925a. The received data is provided to plurality of filters operating at different frequency bands (step 925b). The filters shown in FIG. 6b can process the data as soon as the data is available in parallel with other filters (step 925c). The data processed for multiple frequency bands are added and provided for further compensation (step 925d). In one embodiment, again the steps (925a through 925d) can be divided into a plurality of tasks and designated to a plurality of processing devices 505(aa) through 505(zw).

FIG. 8b is a flow chart depicting how step 930 of flowchart in FIG. 8 can be divided into multiple steps (930a through 930g) wherein array hearing aid device receives the data to be compensated for the hearing deficiencies. The data is provided to the compensation unit 320 in step (930a). The compensation unit 320 verifies if the user has requested any adjustments in the compression ratios or gains because of a change in the environment where the user is presently located (step 930b). If the user didn't request any new changes, then the data received needs to be compensated for. The compensation unit 320 adjusts the data for the pre-determined hearing deficiencies of the user (step 930c). If the user requests any new changes that the data received needs to be compensated for, the compensation unit 320 obtains the compression ratios and gains for the data needed to be compensated for (step 930d), and compresses the data for the new environment (step 930e). Once the steps 930c and 930e are executed, the compensation unit 320 verifies if any further adjustments are required (step 930f), and if no further adjustments are needed, the compensation unit returns to step 935 (step 930g), otherwise the compensation unit returns to step 930d.

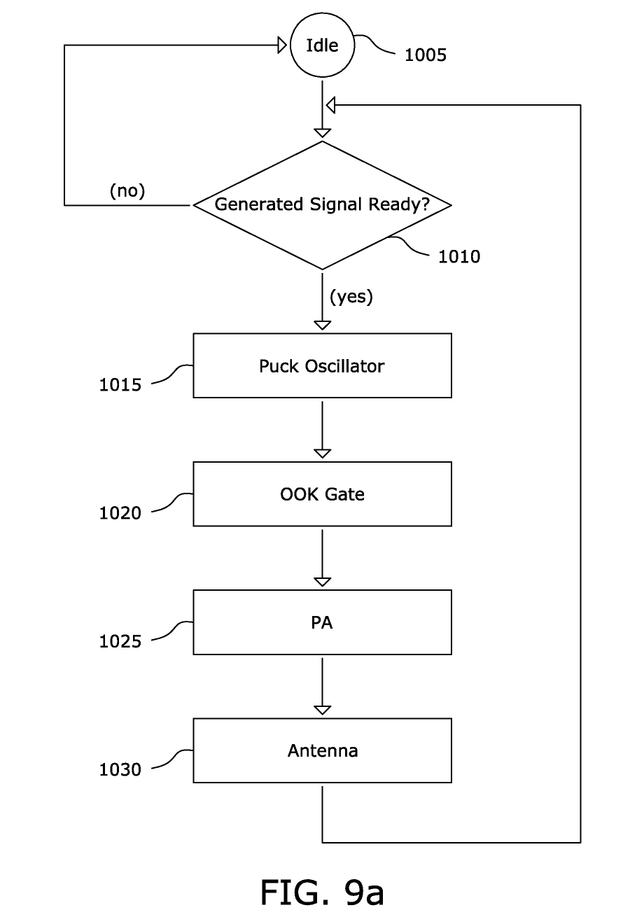

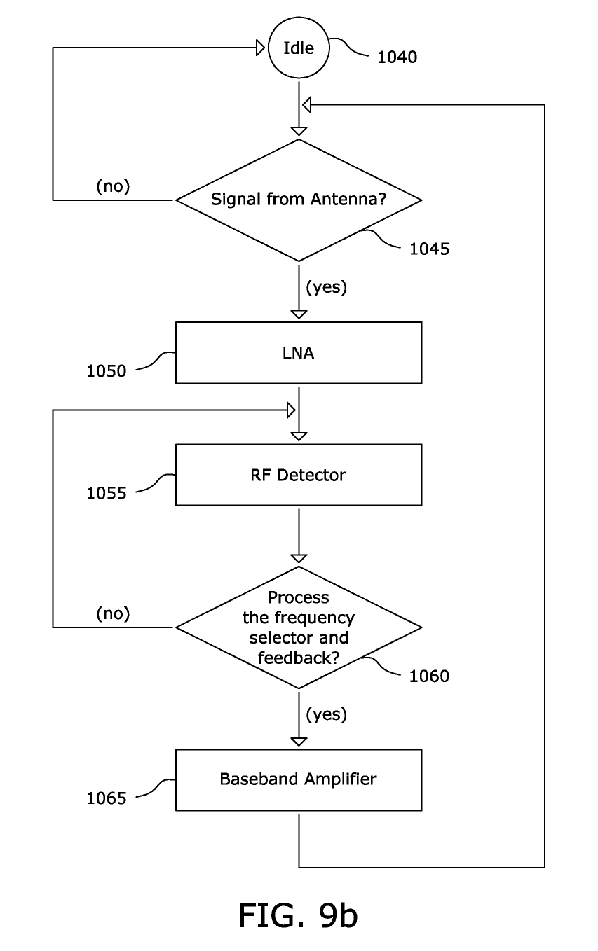

FIG. 9a is a flow chart depicting an embodiment of the method of the operation of the digital transmitter on an array hearing aid system. In the power up condition, the state machine is in an idle state 1005. In a step 1010, the state machine verifies if the signal generator is ready. If the signal generator is ready in a step 1010, then in a step 1015 a puck oscillator is executed in digital form. Otherwise, the state machine returns to the idle state 1005. In a step 1020, an OOK gate is executed in digital form, followed by a power amplification in a step 1025. The signal is then sent and transmitted by means of an antenna in a step 1030.

FIG. 9b is a flow chart depicting an embodiment of the method of the operation of the digital receiver on an array hearing aid system. In the power up condition, the state machine is in an idle state 1040. In a step 1045, the state machine verifies if the antenna is receiving a signal. If the antenna is receiving a signal, then in a step 1050 a low noise amplifier of the signal is executed in digital form. Next in a step 1055, an RF detector is executed in digital form. In a step 1060, the state machine verifies if a frequency selector and a feedback have been processed in the RF detector. If in a step 1060, the frequency selector and the feedback have been processed in the RF detector, then a baseband amplifier is applied to the signal in a step 1065.

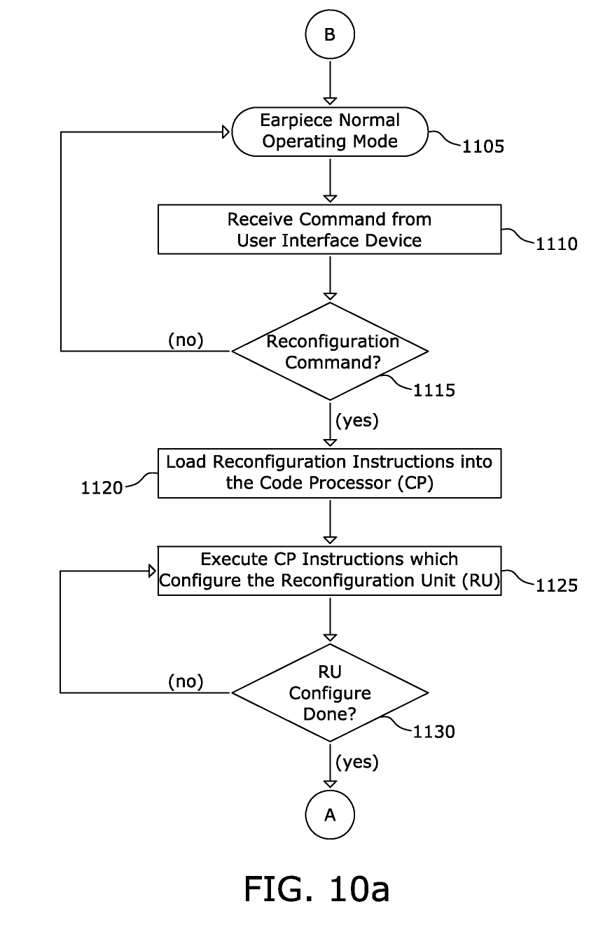

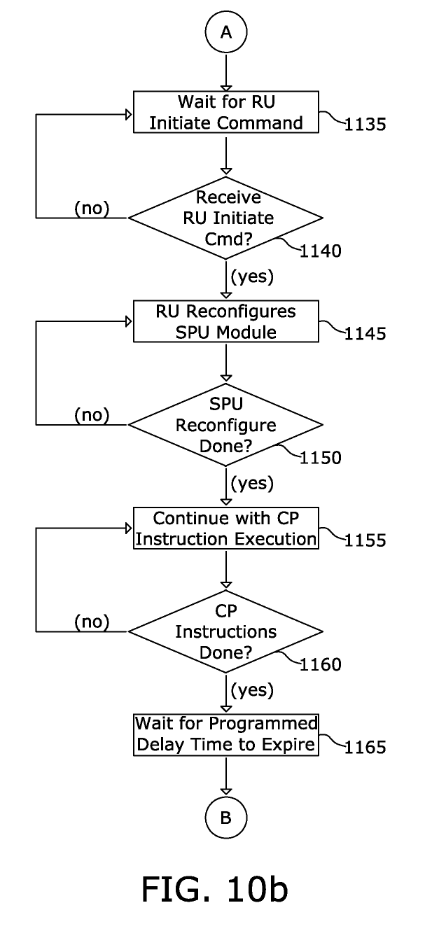

FIG. 10a is a flow chart depicting the first portion of an embodiment of the method of operation of the reconfiguration on an array hearing aid system. The array earpiece is programmed to operate in normal mode (step 1105) upon receiving power. For the purpose of describing this flow diagram, normal operating mode means all operations other than the reconfiguration operation. One of the functions of the normal operating mode is to monitor data and commands being received via array earpiece antenna module 235 of FIG. 3. The data and commands are being transmitted from user interface device 115 of FIG. 1. This process is depicted in the flow diagram as the second step (step 1110). If a command is received, other than a reconfiguration command (step 1115), the array earpiece remains in normal operating mode. If a reconfiguration command is received (step 1115), the reconfiguration process begins by downloading instructions (step 1120) to the code processor (CP) unit of the reconfiguration module 250 of FIG. 3. Those instructions are then executed to configure the reconfiguration unit (RU) (step 1125) with data and timing information that will be used to reconfigure signal processing unit (“SPU”) 220 of FIG. 3. If the reconfiguration is finished at 1130, the process moves on to the steps described in FIG. 10b.

FIG. 10b is the continuation of the FIG. 10a process. After the RU configuration (step 1130) is finished, the CP puts the RU into a WAIT state (step 1135), where the RU is waiting for an initiate command signal from array earpiece antenna module 235 of FIG. 3. When the RU receives the initiate command (step 1140), it performs the reconfiguration sequence on the SPU (step 1145). When the RU has completed the reconfiguration sequence (step 1150), control is returned to the CP to continue instruction execution (step 1155). When the CP finishes the instruction execution (step 1160), reconfiguration module 250 of FIG. 3 will wait for a programmed value of time to expire (step 1165), then return the array earpiece back to the normal mode (step 1105 in FIG. 10a).

Various modifications may be made to the invention without altering its value or scope. For example, while this invention has been described herein using the example of the particular computers 505, many or all of the inventive aspects are readily adaptable to other computer designs, other sorts of computer arrays, and the like.

Similarly, while the present invention has been described primarily herein in relation to use in a hearing aid, the reconfiguration methods and apparatus are usable in many array computers, the same principles and methods can be used, or modified for use, to accomplish other inter-device reconfigurations, such as in general digital signal processing as used in communications between a transmitter and a receiver whether wireless, electrical or optical transmission further including analysis of received communications and radio reflections.

While specific examples of the inventive computer arrays 220, 250, 235, 270 and 265 computers 505, paths 510 and associated apparatus, and the wireless communication method (as illustrated in FIG. 10a and FIG. 10b) have been discussed herein, it is expected that there will be a great many applications for these which have not yet been envisioned. Indeed, it is one of the advantages of the present invention that the inventive methods and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive computer logic array signal processing 220 reconfiguration modules 250 wireless connections 235 and 270 and signal processing methods are intended to be widely used in a great variety of communication applications, including hearing aid systems. It is expected that they will be particularly useful in wireless applications where significant computing power and speed are required.

As discussed previously herein, the applicability of the present invention is such that the inputting information and instructions are greatly enhanced, both in speed and versatility. Also, communications between a computer array and other devices are enhanced according to the described method and means. Since the inventive computer logic array signal processing 220 reconfiguration modules 250 wireless connections 235 and 270 and signal processing methods may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A digital hearing aid comprising: a plurality of microphones for converting acoustic energy into analog electrical signals; and a signal processing unit including plurality of substantially similar processing devices connected to said microphones for digitizing said electrical signal into computer words; and wherein said processing devices further divide said signal into a plurality of frequency bands; and sill further convert said words into an analog sample; and a transducer for converting said signal into acoustic energy.

2. A digital hearing aid as in claim 1, wherein the portion of hearing aid functions include filtering into frequency bands, “analytic magnitude dividing”, and gain adjustment including equalization.

3. A digital hearing aid as in claim 1, wherein an individual processing device, that has completed its processing tasks, enters a power saving mode.

4. A digital hearing aid as in claim 2, wherein said plurality of processing devices process said analog data in parallel.

5. A digital hearing aid as in claim 4, wherein said processors are asynchronous.

6. A digital hearing aid as in claim 1, further comprising a reconfiguration module connected to said signal processing unit for modifying said signal processing unit during operation.

7. A digital hearing aid as in claim 6, wherein said reconfiguration module is further comprising: a non-volatile memory connected to a code processor connected to a reconfiguration unit.

8. A digital hearing aid as in claim 1, further comprising a wireless link.

9. A digital hearing aid as in claim 8, wherein said wireless link further comprises an earpiece module including an antenna for receiving and transmitting electromagnetic radiation; and a transmitter connected to said antenna; and a receiver connected to said antenna.

10. A digital hearing aid as in claim 9, wherein said antenna further comprises a receive antenna and a transmit antenna and switching logic.

11. A digital hearing aid as in claim 10, wherein said transmit antenna and said receive antenna are the same physical structure.

12. A digital hearing aid as in claim 8, wherein said receiver is a super regenerative receiver.

13. A digital hearing aid as in claim 8, wherein said transmitter includes a puck oscillator connected to an OOK gate connected to a power amplifier.

14. A method of operation of an array hearing aid including:
Dividing the tasks of the array hearing aid in plurality of simple tasks;
Distributing the said simpler tasks of the array hearing aid device to plurality of processing devices; and,
Executing said simpler tasks of the array hearing aid device in parallel where possible.

15. A method of operation of an array hearing aid comprising the steps of:
Dividing the tasks of the array hearing aid into a plurality of subtasks; and,
Distributing said subtasks of the array hearing aid device to a plurality of processing devices; and,
Executing said subtasks of the array hearing aid device in parallel.

16. A method of operation of an array hearing aid earpiece as in claim 15, further comprising the step of reconfiguring the array of processing devices in the field.

17. A method of operation of an array hearing aid earpiece as in claim 16, wherein said reconfiguration process of one portion of the processing devices, is performed by other processing devices within the system of array processors.

18. A method of operation of an array hearing aid earpiece according to claim 16, wherein said reconfiguration process is initiated from a remote control device, where the hearing aid earpiece and remote control device constitute an array hearing aid system.

19. A method of operation of an array hearing aid system according to claim 16, wherein said reconfiguration step is performed while the remaining devices in the system or array processors continue to perform their original functions that were configured after the system power on sequence was completed.

20. A method of operation of an array hearing aid system according to claim 16, wherein said portion of device processors are categorized into two types of functions, defined herein as control functions and target functions.

21. A method of operation of an array hearing aid system according to claim 20, wherein said control functions control the reconfiguration process but otherwise do not get reconfigured.

22. A method of operation of an array hearing aid system according to claim 20, wherein said target functions get reconfigured after an initiate command is issued from the remote control device, but otherwise do not participate in the reconfigure control functions.

23. A method of operation of an array hearing aid system according to claim 20, wherein said control functions include steps to prepare, prior to an initiate command, the parameters and properties that will be used to reconfigure the target functions, after an initiate command has been issued from the remote control device.

24. A digital hearing aid with at least one earpiece comprising: a plurality of microphones positioned on said earpiece for converting acoustic energy into analog electrical signals;
and a signal processing unit including plurality of substantially similar processing devices connected to said microphones for digitizing said electrical signal into computer words;
and wherein said processing devices further divide said signal into a plurality of frequency bands; and sill further convert said words into an analog sample; and a transducer positioned in said earpiece for converting said signal into acoustic energy.

25. A digital hearing aid as in claim 24, further comprising: a left earpiece; and, a right earpiece.

26. A digital hearing aid as in claim 25; wherein said left earpiece and said right earpiece are powered by a control unit comprising a power generation source such as a plurality of batteries, solar cells, or equivalent power generation method.
